(19) United States
(12) Patent Application Publication
(10) Pub. No.: US 2019/0214824 A1
(43) Pub. Date: Jul. 11, 2019

(54) POWER GENERATION SYSTEM AND RELATED METHOD OF OPERATING THE POWER GENERATION SYSTEM

(71) Applicant: General Electric Company, Schenectady, NY (US)

(72) Inventors: Amol Rajaram KOLWALKAR, Bangalore (IN); Somakumar RAMACHANDRAPANICKER, Bangalore (IN); Arvind Kumar TIWARI, Bangalore (IN); Subbarao Tatikonda, Bangalore (IN)

(21) Appl. No.: 16/357,574

(22) Filed: Mar. 19, 2019

Related U.S. Application Data
(63) Continuation of application No. 15/236,574, filed on Aug. 15, 2016.

(51) Int. Cl. H02J 3/38; H02J 7/35

(52) U.S. Cl. CPC H02J 3/381; H02J 7/35; H02P 9/007; Y02E 10/563; H02J 3/383

(57) ABSTRACT

A power generation system is disclosed. The power generation system includes a doubly-fed induction generator (DFIG) coupled to a variable speed engine and a photo-voltaic (PV) power source. The DFIG includes a generator to generate a first electrical power based at least partially on an operating speed of the variable speed engine. The PV power source may supply a second electrical power to a Direct Current (DC) link between a rotor side converter and a line side converter of the DFIG. The generator and the line side converter are coupled to an electric grid and/or a local electrical load to supply the first electrical power and at least a portion of the second electrical power to the local electrical load.

### BACKGROUND

The present application relates generally to generation of electrical power and more particularly relates to a power generation system employing a variable speed engine and a photo-voltaic (PV) power source.

Typically, power generation systems such as generators use fuels such as diesel, petrol, and the like to generate an electrical power that can be supplied to local electrical loads. Reducing consumption of the fuels is an ongoing effort in achieving low cost and environment friendly power generation systems. To that end, various hybrid power generation systems are available that use a generator operated by a constant speed engine as primary source of electricity and some form of renewable energy source such as a wind turbine as a secondary source of electricity.

In such hybrid power generation systems, as an amount of power generated by the renewable energy source increases, the power generated by the generators operated by the constant speed engine needs to be reduced. In order to do so, the constant speed engine needs to be operated at low loads. Typically, the constant speed engine has low efficiencies at loads lower than certain threshold limit (e.g., 25%). Moreover, the operation of the constant speed engine at such low loads adversely impacts health of the constant speed engine and overall maintenance cycle.

### BRIEF DESCRIPTION

In accordance with an embodiment of the invention, a power generation system is disclosed. The power generation system includes a variable speed engine, a doubly-fed induction generator (DFIG), and a photo-voltaic (PV) power source. The DFIG includes a generator to generate a first electrical power based at least partially on an operating speed of the variable speed engine, a rotor side converter and a line side converter electrically coupled to the generator, and where the rotor side converter and the line side converter are electrically coupled to each other via a Direct Current (DC) link. The PV power source generates a second electrical power. The PV power source is electrically coupled to the DC-link to supply the second electrical power on the DC-link, where the generator and the line side converter are further coupled to at least one of a local electrical load and an electric grid to supply the first electrical power and at least a portion of the second electrical power to the local electrical load.

In accordance with an embodiment of the invention, a method for operating a power generation system employing a DFIG is disclosed. The DFIG includes a generator electrically coupled to a rotor side converter and a point of common coupling (PCC), the PCC being electrically coupled to a line side converter and at least one of a local electrical load and an electric grid. The method includes determining a desired operating speed of a variable speed engine mechanically coupled to the generator based on an amount of a second electrical power supplied by a PV power source at a DC-link between the rotor side converter and the line side converter of the DFIG and at least one of a load requirement of the local electrical load, an availability of a grid power, power ratings of the rotor side converter and the line side converter, an efficiency of the variable speed engine, and efficiencies of the rotor side converter and the line side converter. The method further includes operating the variable speed engine at the determined operating speed to generate a first electrical power by the generator. Moreover, the method also includes supplying at least one of the first electrical power and at least a portion of the second electrical power to the PCC.

In accordance with an embodiment of the invention, a power generation system is disclosed. The power generation system includes a variable speed engine and a DFIG. The DFIG includes a generator to generate a first electrical power based at least partially on an operating speed of the variable speed engine, a rotor side converter and a line side converter electrically coupled to the generator, where the rotor side converter and the line side converter are electrically coupled to each other via a DC-link. The power generation system further includes at least one of a PV power source to supply a second electrical power and an energy storage device to supply a third electrical power to the DC-link, where the operating speed of the variable speed engine is determined based on at least one of the second electrical power and the third electrical power. Moreover, the generator and the line side converter are coupled to a local electrical to supply the first electrical power and at least a portion of the second electrical power to the local electrical load.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an electrical distribution system, in accordance with an embodiment of the present invention;

FIG. 2 is a graphical representation depicting an example relationship between an operating speed of a variable speed engine and corresponding power generated, in accordance with an embodiment of the present invention; and

FIGS. 3(a) and 3(b) collectively is a flow chart illustrating an example method of operating a power generation system, in accordance with an embodiment of the present invention.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is just for explanatory purposes as the method and the system extend beyond the described embodiments.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified.

Here and throughout the specification and claims, range limitations may be combined and/or interchanged; such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

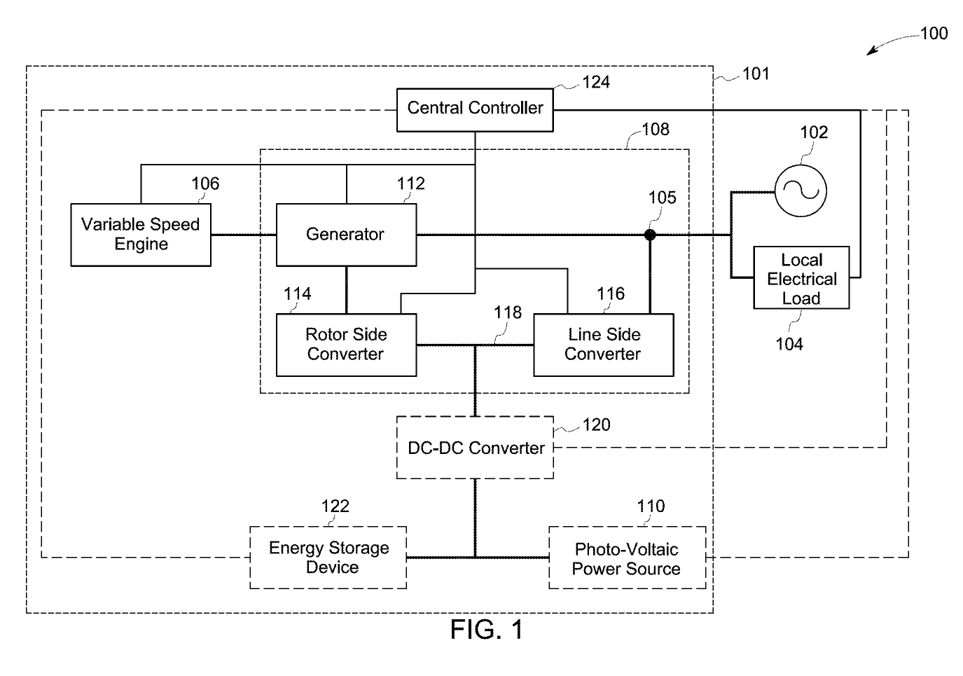

FIG. 1 is a block diagram of an electrical distribution system 100, in accordance with an embodiment of the present invention. The electrical distribution system 100 includes a power generation system 101 coupled to at least one of an electric grid 102 and a local electrical load 104 at a point of common coupling (PCC) 105. In one embodiment of present invention, the power generation system 101 may be coupled to the PCC 105 via a transformer (not shown).

The electric grid 102 may include an interconnected network for delivering electricity from one or more power generating stations (different from the power generation system 101) to consumers (e.g., the electrical load 104) through high/medium voltage transmission lines. The electrical load 104 may be constituted by a plurality of electrical devices that consume electricity either from the electric grid 102 or from the power generation system 101. In some embodiments of present invention, the electric grid 102 may not be available, for example, in case of an islanded mode of operation (will be discussed later). In certain embodiments of present invention, although the power generation system 101 is coupled to the electric grid 102, there may be no power delivered in the electrical distribution system 100 from the electric grid 102 due to fault or outage of the electric grid 102.

The power generation system 101 may include one or more variable speed engines such as a variable speed engine 106, a doubly-fed induction generator (DFIG) 108, and a photo-voltaic (PV) power source 110 and/or an energy storage device 122. The DFIG 108 may include a generator 112, a rotor side converter 114, and a line side converter 116. Further, the power generation system 101 may optionally include a DC-DC converter 120. In one embodiment of the invention, the power generation system 101 may include any of the PV power source 110 or the energy storage device 122 coupled to a Direct Current (DC) link 118 between the rotor side converter 114 and the line side converter 116. Whereas, in some embodiments, the power generation system 101 may include both the PV power source 110 and the energy storage device 122 coupled to the DC-link 118 between the rotor side converter 114 and the line side converter 116. Moreover, the power generation system 101 may also include a central controller 124 operatively coupled to at least one of the variable speed engine 106, DFIG 108, PV power source 110, DC-DC converter 120, and energy storage device 122 to control their respective operations.

The variable speed engine 106 may refer to any system that may aid in imparting controlled rotational motion to rotary element(s) (e.g., the rotor) of the generator 112. For example, the variable speed engine 106 may be an internal combustion engine, an operating speed of which may be varied under the control of the central controller 124. More particularly, the variable speed engine 106 may be a variable speed reciprocating engine where the reciprocating motion of a piston is translated into a rotational speed of a crank shaft connected thereto. The variable speed engine 106 may be operated by combustion of various fuels including, but not limited to, diesel, natural gas, petrol, LPG, biogas, producer gas, and the like. The variable speed engine 106 may also be operated using waste heat cycle. It is to be noted that the scope of the present specification is not limited with respect to the types of fuel and the variable speed engine 106 employed in the power generation system 101.

The variable speed engine 106 may be mechanically coupled to the DFIG 108. More particularly, the crank shaft of the variable speed engine 106 may be coupled to the rotor of the generator 112, thereby rotating a rotor of the generator 112. In some embodiments of present invention, the crank shaft of the variable speed engine 106 may be coupled to a rotor shaft of the generator 112 through one or more gears. As will be appreciated, due to such coupling of the variable speed engine 106 with the generator 112, a rotational speed of the rotor of the generator 112 can also be varied depending on the operating speed of the variable speed engine 106.

In one embodiment of present invention, the generator 112 may be a wound rotor induction generator. The generator 112 includes a stator (not shown) and the rotor (not shown). The stator includes a first electrical winding disposed thereon. Similarly, the rotor includes a second electrical winding disposed thereon. As previously noted, the rotor is mechanically coupled to the variable speed engine 106. Consequently, the generator 112 may generate a first electrical power (voltage and current) depending on at least one of the operating speed of the variable speed engine 106 and an electrical excitation provided to the first electrical winding and/or the second electrical winding. Moreover, the generator 112 is electrically coupled to the PCC 105 to provide the first electrical power at the PCC 105. More particularly, the first electrical winding on the stator is coupled (directly or indirectly) to the PCC 105.

The rotor side converter 114 is electrically coupled to the line side converter 116 and the second electrical winding on the rotor of the generator 112. In one example, the rotor side converter 114 and the line side converter 116 are electrically coupled to each other via a Direct Current (DC) link 118. The line side converter 116 may be coupled to the PCC 105, directly or via a transformer. Each of the rotor side converter 114 and the line side converter may act as either an Alternating Current (AC)-DC converter or a DC-AC under the control of the central controller 124.

Furthermore, the power generation system 101 also includes the PV power source 110 electrically coupled to the DFIG 108. The PV power source 110 typically includes one or more PV arrays (not shown), where each PV array may include at least one PV module. A PV module may include a suitable arrangement of a plurality of PV cells (diodes and/or transistors). The PV power source 110 generates a DC voltage constituting a second electrical power depending on solar insolation, weather conditions, and/or time of day. In some embodiments of present invention, the PV power source 110 may be electrically coupled to the DFIG 108 at the DC-link 118 to supply the second electrical power generated by the PV power source 110 to the DC-link 118. Moreover, in some other embodiments of present invention, the PV power source 110 may be electrically coupled to the DFIG 108 at the DC-link 118 via the DC-DC converter 120 to supply the second electrical power.

As the PV power source 110 may be electrically coupled to the DC-link 118 to supply the second electrical power, power ratings of the rotor side converter 114 and the line side converter 116 needs to be appropriately selected. The power ratings of the rotor side converter 114 and the line side converter 116 may be referred to as a maximum amount of power that can be handled by each of the rotor side converter 114 and the line side converter 116. In one embodiment of present invention, the power ratings of the rotor side converter 114 and the line side converter 116 are selected based on a maximum amount of the second electrical power producible by the PV power source 110 (hereinafter also referred to as “PV rating”). For example, the value of the power rating of each of the rotor side converter 114 and the line side converter 116 may be selected equal to half of the PV rating. The power ratings of the rotor side converter 114 and the line side converter 116 thus selected, may aid in operating the rotor side converter 114 and the line side converter 116 at their respective maximum efficiencies under the control of the central controller 124.

Additionally, in some embodiments of present invention, the power generation system 101 may also include the energy storage device 122 coupled the PV power source 110. More particularly, the energy storage device 122 is coupled to the DC-link 118. In one embodiment of present invention, the energy storage device 122 is coupled to the DC-link 118 through the DC-DC converter 120. By way of example, the energy storage device 122 may include arrangements of one or more batteries, capacitors, and the like.

In one embodiment of present invention, the central controller 124 may be capable of executing program instructions for controlling operations of the variable speed engine 106, the DFIG 108, the plurality of electrical devices constituting the local electrical load 104, and/or the DC-DC converter 120. By way of example, the central controller 124 may be a general purpose computer. Alternatively, the central controller 124 may be implemented as hardware elements such as circuit boards with processors or as software running on a processor such as a commercial, off-the-shelf personal computer (PC), or a microcontroller. In certain embodiments, the variable speed engine 106, the rotor side converter 114, the line side converter 116, the energy storage device 122, and/or the DC-DC converter 120 may include controllers/control units/electronics to control their respective operations under a supervisory control of the central controller 124.

Operation of the power generation system 101 will now be described for various operating conditions.

The power generation system 101 may be operated in a grid connected mode of operation, in a transition mode of operation, or in an islanded mode of operation. The grid connected mode of operation is defined as a situation when a grid power is being supplied/available at the PCC 105 from the electric grid 102. The transition mode of operation is defined as a mode of operation when the power generation system 101 is to be transitioned from the grid connected mode of operation to the islanded mode of operation. More particularly, such situation arises when the grid power cuts-off and the power generation system 101 needs to be controlled to generate sufficient electrical power to meet a load requirement of the local electrical load 104. Similarly, the islanded mode of operation is defined as a situation when the power generation system 101 is not connected to the electric grid 102 and configured to meet the load requirement on a stand-alone basis.

In the grid connected, the transition, and/or the islanded modes of operation, the central controller 124 is configured to control operations of one or more of the variable speed engine 106, the DFIG 108, and the DC-DC converter 120 based on at least one of the load requirement of the local electrical load 104, an availability of the grid power, the power ratings of the rotor side converter 114 and the line side converter 116, an amount of the second electrical power generated by the PV power source 110, an efficiency of the variable speed engine 106, and efficiencies of the rotor side converter 114 and the line side converter 116. The efficiency of the variable speed engine 106 may be defined as a percentage of a chemical energy (e.g., an energy generated due to burning of fuels) that is translated in to mechanical power output of the variable speed engine 106. Similarly, efficiencies of the rotor side converter 114 and the line side converter 116 may refer to a ratio of a respective output power and an input power.

The central controller 124 may determine that the power generation system 101 has to operate in the grid connection mode of operation based on a detection of the grid power. In the grid connected mode of operation, if sufficient second electrical power is generated by the PV power source 110 to meet the load requirement, although the grid power is available, the power generation system 101 preferably utilizes the second electrical power, leading to a greener environment. In the grid connected mode of operation, if the generated second electrical power is not sufficient to meet the load requirement, a remaining power may be supplied from the electric grid 102 to meet the load requirement. The central controller 124 is configured to reduce the operating speed of the variable speed engine 106 zero or substantially close to zero as the grid power is available from the electric grid 102. In one embodiment of present invention, the central controller 124 may send a first control signal to the variable speed engine 106 to stop its operation. However, in certain embodiments of present invention, to avoid start-up delays the variable speed engine 106 may be operated at very low speeds (substantially close to zero), for example, in instances when there is a significant variability in the second electrical power generated by the PV power source 110.

The second electrical power generated by the PV power source 110 may be supplied to the local electrical load 104 via the rotor side converter 114 and/or the line side converter 116. With an aim to operate the rotor side converter 114 and the line side converter 116 at their respective optimum efficiencies, the central controller 124 is configured to determine a need of operating the rotor side converter 114 and/or the line side converter 116 depending on the amount of the second electrical power generated by the PV power source 110, the power ratings and/or the efficiencies of the rotor side converter 114 and the line side converter 116.

For example, if the amount of the second electrical power is less than the power rating of the line side converter 116, the second electrical power is supplied to the PCC 105 via the line side converter 116. In order to enable the supply of the second electrical power via the line side converter 116, the central controller 124 communicates a second control signal to the line side converter 116, thereby operating the line side converter 116 as a DC-AC converter. However, if the amount of the second electrical power generated by the PV power source 110 is greater than the power rating of the line side converter 116, the amount equal to the power rating of the line side converter 116 is supplied through the line side converter 116 (as DC-AC converter). Whereas, the portion of the second electrical power in excess to the power rating of the line side converter 116 may be supplied to the PCC 105 via the combination of the rotor side converter 114 and the generator 112, where the generator 112 may be utilized as a transformer. In order to enable the supply of the excess portion of the second electrical power via the rotor side converter 114, the central controller 124 communicates a third control signal to the rotor side converter 114, thereby operating the rotor side converter 114 as a DC-AC converter. More particularly, the excess portion of the second electrical power may be supplied to the second electrical winding on the rotor of the generator 112 and is extracted from the first electrical winding on the stator of the generator 112.

In some embodiments of present invention, the power generation system 101 may be operated in an islanded mode as the electric grid 102 is not available at the locations where the power generation system 101 is installed to operate. Alternatively, the central controller 124 may determine that the power generation system 101 has to operate in the islanded mode by detecting the absence of the grid power. In the islanded mode of operation, both the variable speed engine 106 and the PV power source 110 may be operational. The central controller 124 may be configured to determine the operating speed of the variable speed engine 106 based on one or more of the load requirement of the local electrical load 104, the amount of the second electrical power being generated by the PV power source 110, an amount of the third electrical power obtainable from the energy storage device 122, the power ratings and/or the efficiencies of the rotor side converter 114 and the line side converter 116.

In some embodiments of present invention, the central controller 124 is configured to control the power generation system 101 such that the full amount of the second electrical power generated by the PV power source 110 is utilized to meet the load requirement. Consequently, the central controller 124 may be configured to determine if the second electrical power is insufficient to meet the load requirement. If it is determined by the central controller 124 that the second electrical power is insufficient to meet the load requirement, the central controller 124 may be configured to identify an amount of the desired first electrical power through the generator 112. In one embodiment of present invention, if the requirement of the first electrical power is lower than a threshold value, the central controller 124 is configured to enable a supply of a portion of the third electrical power from the energy storage device 122 to the PCC via the rotor side converter 114 and the generator 112, where the generator 112 may function as a transformer. In such an instance, the variable speed engine 106 may be kept off.

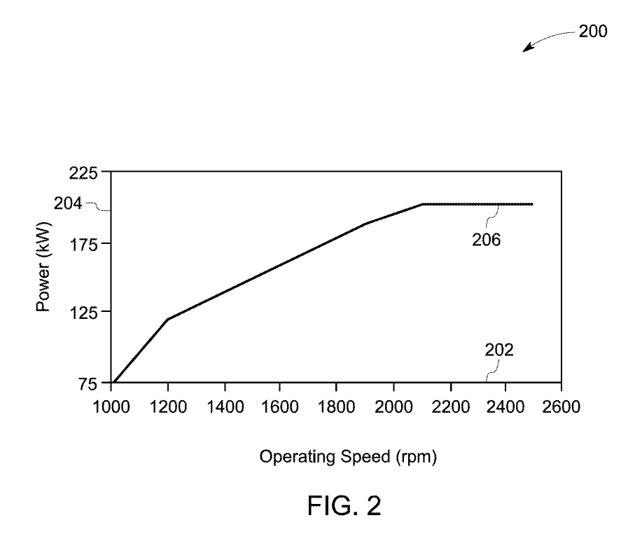

In another embodiment of present invention, the central controller 124 is configured to determine a desired operating speed of the variable speed engine 106 corresponding to a remaining amount of the load requirement that cannot supplied from the second electrical power. The central controller 124 may determine the desired operating speed of the variable speed engine 106 based on a relationship between the operating speed of a variable speed engine 106 and corresponding power generated (see FIG. 2).

FIG. 2 is a graphical representation 200 depicting an example relationship between the operating speed of the variable speed engine 106 and corresponding power generated, in accordance with an embodiment of the present invention. The X-axis 202 of the graphical representation 200 represents the operating speed of the variable speed engine 106 and the Y-axis 204 of the graphical representation 200 represents a corresponding amount of the first power generated by the generator 112. A curve 206 represents the relationship between the operating speed 202 of the variable speed engine 106 and the power 204 generated by the generator 112. It is to be noted that values represented in the graphical representation 200 are for the purpose of illustration and may be different for different combinations of variable speed engines and DFIG employed in the power generation system 101.

Such relationship between the operating speed 202 and the power 204 may be stored in a memory associated with the central controller 124. By way of example, such data may be stored in a form of a look-up table. Alternatively, central controller 124 may be capable of developing a mathematical model based on the relationship between the operating speed 202 and the power 204 as depicted in FIG. 2.

For example, if the load requirement of the local electrical load 104 is 200 kW and the second electrical power generated by the PV power source 110 is 100 kW, the central controller 124 may determine that the remaining power of 100 kW needs to be supplied by the variable speed engine 106. Consequently, the central controller 124 is configured to determine the corresponding desired operating speed of the variable speed engine 106 based on the relationship as depicted in FIG. 2. For example, based on the relationship between the operating speed 202 and the power 204, the central controller 124 may determine that the desired operating speed of the variable speed engine 106 should be about 1160 rpm to generate the power of 100 kW.

Moreover, depending on the power rating of the line side converter 116 a portion of the second electrical power may be supplied to the PCC 105 through the line side converter 116, whereas, a remaining portion of the second electrical power needs to be supplied through the rotor side converter 114 depending on the associated power rating, or vice versa. For example, if the power rating of the line side converter 116 is 77 kw, the remaining portion (23 kw) of the second electrical power needs to be supplied though the rotor side converter 114 to the second electrical winding on the rotor of the generator 112. Thus, the total first electrical power available at the first electrical winding of the stator of the generator 112 is 123 kW that may be supplied to the PCC 105. Consequently, the total power supplied at the PCC is 200 kW.

In another example, when the second electrical power is not available, for example, during a night time or during maintenance of the PV power source 110, the central controller 124 is configured to run variable speed engine 106 at higher operating speeds. For example, if no second electrical power is available and the load requirement is still 200 KW, the variable speed engine 106 needs to be operated at an operating speed of about 2000 rpm. A part of the generated power may be provided through the rotor side converter 114 (e.g., by operating the rotor side converter 114 as AC-DC converter) and the line side converter 116 (e.g., by operating the line side converter 116 as DC-AC converter) under the control of the central controller 124.

Further, in some embodiments, when the load requirement reduces and the variable speed engine 106 is yet to operate at the reduced operating speed, a portion of the first electrical power may be stored in the energy storage device 122 under the control of the central controller 124. For example, in order to store the portion of the first electrical power in the energy storage device 122, the central controller 124 may be configured to operate at least one of the line side converter 116 and the rotor side converter 114 as AC-DC converters.

Moreover, as previously discussed, the power generation system 101 may also be operated in the transition mode of operation. If the central controller 124 determines that the grid power is discontinued, the central controller 124 controls the variable speed engine 106, the DFIG 108, and/or the DC-DC converter 120 to meet the load requirement. As previously noted, in the grid connected mode of operation, the variable speed engine 106 may be turned off or operated at a very low speeds. If the variable speed engine 106 is kept turned off in the grid connected mode of operation, the central controller 124 is configured to start (i.e., turn-on) the variable speed engine 106 as soon as the central controller 124 determines that the grid power is discontinued. In some embodiments of present invention, in order to start the variable speed engine 106, the central controller 124 may operate the rotor side converter 114 or the line side converter 116 to enable a supply of a portion of the third electrical power from the energy storage device 122 to the generator 112, thereby operating the generator 112 as a motor. Rotation of the rotor of the generator 112 may in turn drive the variable speed engine 106, thereby turning-on the variable speed engine 106. Gradually, the variable speed engine 106 is to be operated to transition into the islanded mode as described hereinabove.

In some embodiments of present invention, in the transition mode of operation, if the amount of the second electrical power is less than the load requirement and the variable speed engine 106 has not reached a desired operating speed, the central controller 124 is configured to control a set of electrical devices from the plurality of electrical devices constituting the local electrical load 104 to reduce the load requirement. In one embodiment of present invention, the central controller 124 is configured to control the set of electrical devices by turning-off the set of electrical devices or by discontinuing the supply of electricity to the set of electrical devices. In another embodiment of present invention, the central controller 124 is configured to operate the set of electrical devices in low power mode, thereby lowering the load requirement.

Moreover, as previously noted, the energy storage device 122 may also be coupled to the DC-link 118. Therefore, in some embodiments of present invention, if the amount of the second electrical power is less than the load requirement and the variable speed engine 106 has not reached the desired operating speed, the central controller 124 is configured to supply a portion of a third electrical power from the energy storage device 122 to the local electrical load to meet the load requirement.

In any of the grid connected mode of operation or islanded mode of operation, in some embodiments, the PV power source 110 may be operated at a Maximum Power Point (MPP) to maximize the energy capture from solar energy. The central controller 124 may be configured to control whether or not the PV power source 110 to be operated at the MPP based on the load requirement and the first electrical power.

Further, in any of the grid connected mode of operation or islanded mode of operation, the central controller 124 may further be configured to determine if the rotor side converter 114 and the line side converter 116 are operating normally. If it is determined by the central controller 124 that the rotor side converter 114 malfunctions, the central controller 124 operates the line side converter 116 to pass therethrough all of the second electrical power generated by the PV power source 110. In such a case, the power rating of the line side converter 116 needs at least equal to PV rating. Moreover, the generator 112 may be operated in a self-excited mode. In the self-excited mode, reactive power may be supplied by one or more capacitor banks (not shown) coupled to at least one of the first electrical winding on the stator and the second electrical winding on the rotor of the generator 112.

However, in one embodiment of present invention, if it is determined by the central controller 124 that the line side converter 116 malfunctions, the central controller 124 operates the rotor side converter 114 to pass therethrough all of the second electrical power generated by the PV power source 110 which may be available at the first electrical winding on the stator. In such a case, the power rating of the rotor side converter 114 needs at least equal to the PV rating. In another embodiment of present invention, if it is determined by the central controller 124 that the line side converter 116 malfunctions, the central controller 124 operates the rotor side converter 114 to pass therethrough a portion of the second electrical power generated depending on the power rating of the rotor side converter 114. However, in such an instance, only a part of the load requirement may be met. In some embodiments of present invention, the central controller 124 is configured to store at least a portion of the second electrical power in the energy storage device 122 if the line side converter 116 malfunctions.

Moreover, if it is determined by the central controller 124 that both the rotor side converter 114 and the line side converter 116 malfunction, the central controller 124 may be configured to operate the generator 112 in a self-excited mode and a part of the load requirement may be supplied depending on a maximum power producible by the generator 112. In the self-excited mode, reactive power may be supplied by the one or more capacitor banks coupled to at least one of the first electrical winding on the stator and the second electrical winding on the rotor of the generator 112. Moreover, the central controller 124 may be configured to operate the DC-DC converter 120 to store the generated second electrical power in the energy storage device 122 if both the rotor side converter 114 and the line side converter 116 malfunction.

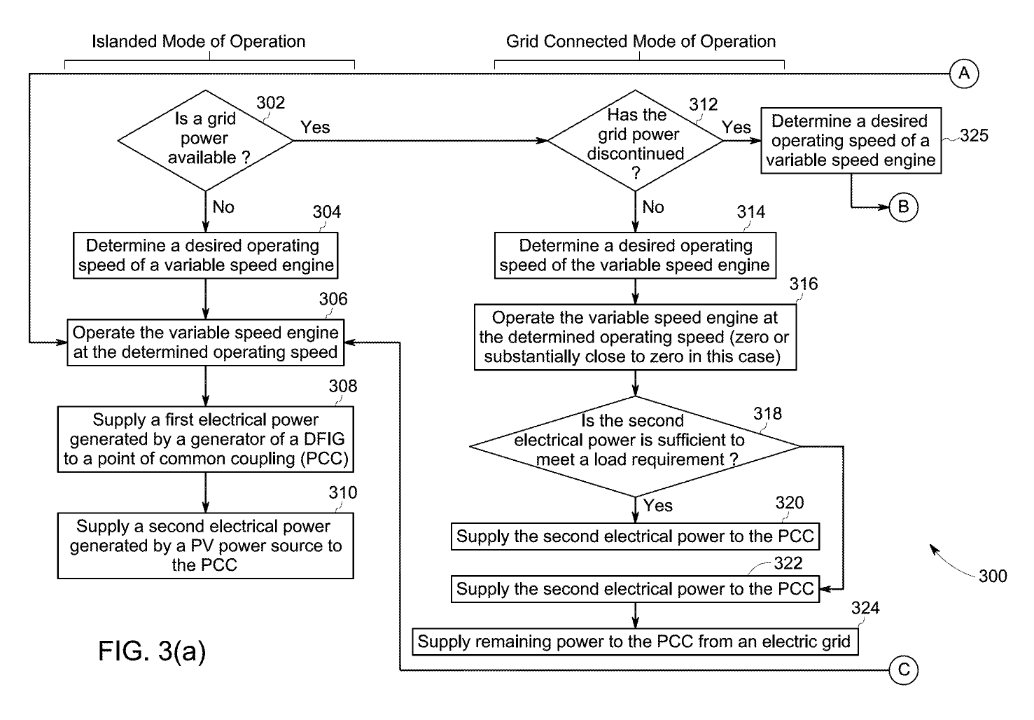

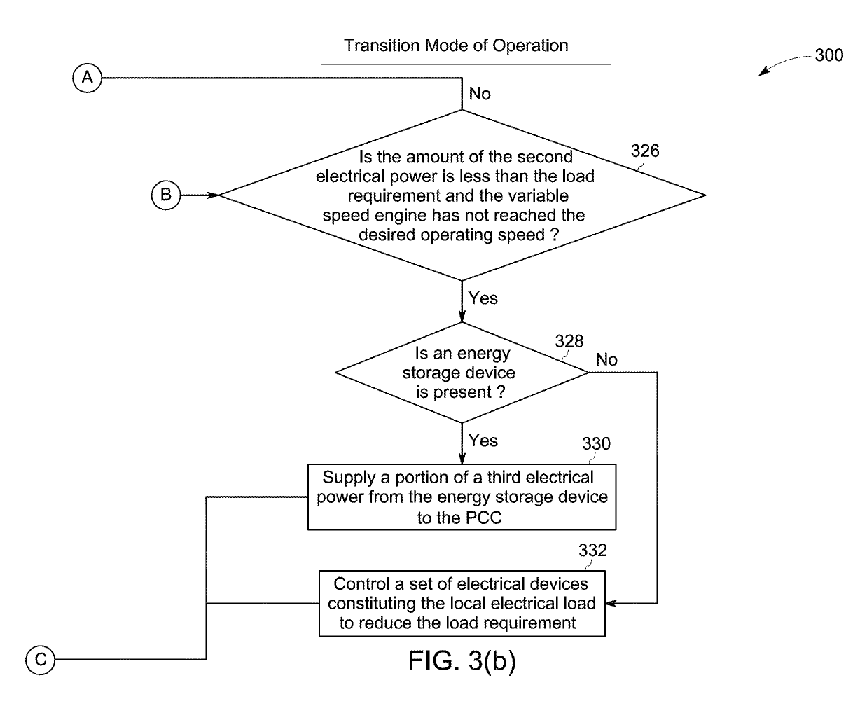

FIGS. 3(a) and 3(b) collectively is a flow chart 300 illustrating an example method of operating the power generation system 101 of FIG. 1, in accordance with an embodiment of the present invention. FIG. 3 will be described in conjunction with the elements of FIG. 1. As previously noted, the power generation system 101 is employed in the distribution system 100 where the power generation system 101 may be coupled to the electric grid 102 and/or the local electrical load 104. Moreover, the power generation system 101 includes the variable speed engine 106, the DFIG 108, the PV power source 110, and/or the DC-DC converter 120 coupled as depicted in FIG. 1. Also, the DFIG 108 includes the generator 112, the rotor side converter 114, and the line side converter 116.

At step 302, a check is be performed by the central controller 124 to determine if the grid power is available. At step 302, if it is determined that the grid power is available, control transfers to step 312 (to be discussed later). However, if it is determined that the grid power is not available, the central controller 124 may determine that the power generation system 101 needs to be operated in an islanded mode of operation. Alternatively, the step 302 may be avoided if the power generation system 101 is specifically installed to operate in the islanded mode as no electric grid may be available. In the islanded mode of operation, a desired operating speed of the variable speed engine 106 may be determined by the central controller 124, as indicated by step 304. The desired operating speed of the variable speed engine 106 may be determined based on an amount of a second electrical power supplied by the PV power source 110 at the DC-link 118 and at least one of a load requirement of the local electrical load 104, the power ratings of the rotor side converter 114 and the line side converter 116, the efficiency of the variable speed engine 106, and the efficiencies of the rotor side converter 114 and the line side converter 116. In some embodiments, when the energy device 122 is coupled to the DC-link 118, the central controller 124 may determine the desired operating speed of the variable speed engine 106 based on an amount of a third electrical power obtainable from the energy storage device 122.

Moreover, the variable speed engine 106 may be operated the determined operating speed, as indicated by step 306, to generate a first electric power by a generator 112. At step 308, the first electrical power is supplied to the PCC 105. Additionally, the second electrical power may be supplied to the PCC 105 through at least one of the rotor side converter 114 and the line side converter 116, as indicated by step 310, the details of which have been described in the description hereinabove.

Referring again to step 302, if it is determined that the grid power is available, control transfers to step 312 where the central controller 124 is further configured to perform another check to determine if the grid power has been discontinued/lost. At step 312, if it is determined that the grid power has been discontinued, control transfers to step 326 (to be discussed later). However, if it is determined that the grid power is present (i.e., not discontinued), the central controller 124 may determine that the power generation system 101 needs to be operated in a grid connected mode of operation where a desired operating speed of the variable speed engine 106 may be determined by the central controller 124, as indicated by step 314. More particularly, as the grid power is available, the desired operating speed of the variable speed engine 106 may be zero or substantially close to zero. Consequently, the variable speed engine 106 may be operated at the determined speed (e.g., zero or substantially close to zero), as indicated by step 316.

At step 318, a check may be carried out by the central controller 124 to determine if the second electrical power generated by the PV power source 110 is sufficient to meet the load requirement. If it is determined at step 318 that the second electrical power is sufficient to meet the load requirement, the second electrical power is supplied at the PCC 105, as indicated by step 320. The second electrical power is supplied at the PCC 105 through at least one of the rotor side converter 114 and the line side converter 116 under the control of the central controller 124. However, if it is determined at step 318 that the second electrical power is not sufficient to meet the load requirement, the available second electrical power is supplied at the PCC 105, as indicated by step 322. Moreover, at step 324, remaining amount of the load requirement may be satisfied by supplying the grid power, as indicated by step 324.

Referring again to step 312, if it is determined that the grid power has been discontinued, the central controller 124 may determine that the power generation system 101 has to be operated in a transition mode of operation to transition the power generation system 101 into the islanded mode of operation. Therefore, at step 325, a desired operating speed of the variable speed engine may be determined by the central controller 124. In some embodiments of present invention, the desired operating speed determined at step 325 is same as the desired operating speed determined at step 304 as the power generation system 101 has to be transitioned in the islanded mode.

Moreover, at step 326, another check may be carried out by the central controller 124 to determine if the amount of the second electrical power is less than the load requirement and the variable speed engine 106 has not reached a desired operating speed determined at step 325. At step 326, if it is determined that the second electrical power is not less than the load requirement and the variable speed engine 106 has reached the desired operating speed determined at step 325, the control transfers to step 306. However, at step 326, if it is determined that the second electrical power is less than the load requirement and the variable speed engine 106 has not reached the desired operating speed determined at step 325, another check may be carried out by the central controller 124 to determine if one or more energy storage devices such as the energy storage device 122 is present.

At step 328, if it is determined that the energy storage device 122 is present, a portion of a third electrical power from the energy storage device 122 is supplied to the PCC 105 to meet the load requirement, as indicated by step 330. In order to enable the supply of the portion of the third electrical power, the central controller 124 may suitably operate the DC-DC converter 120, the rotor side converter 114 and/or the line side converter 116. However, at step 328, if it is determined that the energy storage device 122 is not present, a set of electrical devices constituting the local electrical load 104 may be controlled (e.g., turned off or operated in a low power mode), at least temporarily, to reduce the load requirement, as indicated by step 332. Subsequently, the control may be transferred to step 306.

Any of the foregoing steps and/or system elements may be suitably replaced, reordered, or removed, and additional steps and/or system elements may be inserted, depending on the needs of a particular application, and that the systems of the foregoing embodiments may be implemented using a wide variety of suitable processes and system elements and are not limited to any particular computer hardware, software, middleware, firmware, microcode, etc.

Furthermore, the foregoing examples, demonstrations, and method steps such as those that may be performed by the central controller 124 may be implemented by suitable code on a processor-based system, such as a general-purpose or special-purpose computer. Different implementations of the systems and methods may perform some or all of the steps described herein in different orders, parallel, or substantially concurrently. Furthermore, the functions may be implemented in a variety of programming languages, including but not limited to C++or Java. Such code may be stored or adapted for storage on one or more tangible or non-transitory computer readable media, such as on data repository chips, local or remote hard disks, optical disks (that is, CDs or DVDs), memory or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

In accordance with some embodiments of the invention, the power generation system may be operated at higher efficiencies by ensuring that converters (the rotor side converter and the line side converter) and the variable speed engine are operated at the best efficiency for a given load requirement. Moreover, wear and tear of the variable speed engine may also be reduced, since lower speed of operation increases the life of internal mechanical components of the variable speed engine. A fault tolerant mechanism discussed hereinabove may aid in fulfilling the load requirement, fully or at least partially, irrespective of the malfunctioning of the converters. Moreover, the PV power source may be utilized as primary power source leading to more environmental friendly power generation system. Additionally, in various embodiments described hereinabove, the first electrical power generated by operation of the variable speed engine may be utilized in situations when the second electrical power from the PV power source and/or the third electrical power from the energy storage device are not available or are insufficient to meet the load requirement. Such a controlled utilization of the power from the variable speed engine aids in reducing overall fuel consumption by the variable speed engine, thereby leading to a cost effective and an environment friendly power generation system.

The present invention has been described in terms of some specific embodiments. They are intended for illustration only, and should not be construed as being limiting in any way. Thus, it should be understood that modifications can be made thereto, which are within the scope of the invention and the appended claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A power generation system, comprising:
a variable speed engine;
a doubly-fed induction generator (DFIG), wherein the DFIG comprises a generator to generate a first electrical power based at least partially on an operating speed of the variable speed engine, a rotor side converter and a line side converter electrically coupled to the generator, and wherein the rotor side converter and the line side converter are electrically coupled to each other via a Direct Current (DC) link; and
a photo voltaic (PV) power source to generate a second electrical power and electrically coupled to the DC-link to supply the second electrical power to the DC-link,
wherein the generator and the line side converter are further coupled to at least one of a local electrical load and an electric grid.

2. The power generation system of claim 1, the generator and the line side converter are coupled to at least one of the local electrical load and the electric grid to supply the first electrical power and at least a portion of the second electrical power to the local electrical load.

3. The power generation system of claim 1, wherein the variable speed engine may be operated by utilizing diesel, natural gas, a waste heat cycle, a producer gas, a biogas, or combination thereof.

4. The power generation system of claim 1, wherein the PV power source is coupled to the DC-link via a DC-DC converter.

5. The power generation system of claim 1, further comprising a central controller operatively coupled to one or more of the variable speed engine, the DFIG, and the PV power source, wherein the central controller is configured to control operations of one or more of the variable speed engine and the DFIG based on at least one of a load requirement of the local electrical load, an availability of a grid power, power ratings of the rotor side converter and the line side converter, an amount of the second electrical power generated by the PV power source, an efficiency of the variable speed engine, and efficiencies of the rotor side converter and the line side converter.

6. The power generation system of claim 5, wherein the power ratings of the rotor side converter and the line side converter are selected based on a maximum amount of the second electrical power producible by the PV power source.

7. The power generation system of claim 6, wherein the power rating of each of the rotor side converter and the line side converter is equal to half of the maximum amount of the second electrical power producible by the PV power source.

8. The power generation system of claim 5, wherein the central controller is configured to reduce the operating speed of the variable speed engine to zero or substantially close to zero if the grid power is available.

9. The power generation system of claim 5, wherein, if the grid power is available, the central controller is further configured to supply at least a part of the second electrical power to the local electrical load through at least one of the rotor side converter and the line side converter depending on the amount of the second electrical power and the power ratings of the rotor side converter and the line side converter.

10. The power generation of claim 5, wherein, if the grid power is not available, the amount of the second electrical power is less than the load requirement, and the variable speed engine has not reached a desired operating speed, the central controller is configured to control a set of electrical devices constituting the local electrical load to reduce the load requirement.

11. The power generation of claim 5, further comprising one or more energy storage devices coupled to the PV power source or the DC-link.

12. The power generation of claim 11, wherein, if the grid power is not available, the amount of the second electrical power is less than the load requirement, and the variable speed engine has not reached a desired operating speed, the central controller is configured to supply a third electrical power from the one or more energy storage devices to the local electrical load to meet the load requirement.

13. The power generation of claim 12, wherein the central controller is configured to enable a supply of a portion of the third electrical power from the one or more energy storage devices to the local electrical load if requirement of the first electrical power is lower than a threshold value.

14. The power generation of claim 11, wherein the central controller is configured to store at least a portion of the second electrical power in the one or more energy storage devices if the line side converter malfunctions.

15. The power generation of claim 11, wherein the one or more energy storage devices are electrically coupled to the variable speed engine to supply a power to start the variable speed engine.

16. The power generation of claim 5, wherein, if the grid power is not available, the central controller is configured to operate the variable speed engine at the operating speed that is determined based on the load requirement and the amount of the second electrical power being generated by the PV power source.

17. A method of operating a power generation system employing a doubly-fed induction generator (DFIG), wherein the DFIG comprises a generator electrically coupled to a rotor side converter and a point of common coupling (PCC), the PCC being electrically coupled to a line side converter and at least one of a local electrical load and an electric grid, the method comprising:
determining a desired operating speed of a variable speed engine mechanically coupled to the generator based on an amount of a second electrical power supplied by a photo voltaic (PV) power source at a Direct Current (DC) link between the rotor side converter and the line side converter of the DFIG and at least one of a load requirement of the local electrical load, an availability of a grid power, power ratings of the rotor side converter and the line side converter, an efficiency of the variable speed engine, and efficiencies of the rotor side converter and the line side converter;
operating the variable speed engine at the determined desired operating speed to generate a first electrical power by the generator; and
supplying at least one of the first electrical power and at least a portion of the second electrical power to the PCC.

18. The method of claim 17, further comprising, if the grid power is not available, the amount of the second electrical power is less than the load requirement, and the variable speed engine has not reached a desired operating speed, controlling a set of electrical devices constituting the local electrical load to reduce the load requirement.

19. The method of claim 17, further comprising, if the grid power is not available, determining the operating speed of the variable speed engine based on the load requirement and the amount of the second electrical power being generated by the PV power source.

20. The method of claim 17, further comprising operating the generator in a self-excited mode if the rotor side converter malfunctions.

21. A power generation system, comprising:
a variable speed engine;
a doubly-fed induction generator (DFIG), wherein the DFIG comprises a generator to generate a first electrical power based at least partially on an operating speed of the variable speed engine, a rotor side converter and a line side converter electrically coupled to the generator, and wherein the rotor side converter and the line side converter are electrically coupled to each other via a Direct Current (DC) link; and
at least one of a photo voltaic (PV) power source to supply a second electrical power and an energy storage device to supply a third electrical power to the DC-link, wherein the operating speed of the variable speed engine is determined based on at least one of the second electrical power and the third electrical power, and
wherein the generator and the line side converter are further coupled to a local electrical load to supply the first electrical power and at least a portion of the second electrical power to the local electrical load.
